(19) United States
(12) Patent Application Publication
(10) Pub. No.: US 2019/0190743 A1
(43) Pub. Date: Jun. 20, 2019

(54) TECHNOLOGIES FOR MONITORING THE PERFORMANCE OF HOME APPLIANCES

(71) Applicant: Vectren Customer Solutions, LLC, Evansville, IN (US)

(72) Inventors: Balaji Vishnumolakala, Carmel, IN (US); Joseph Sannella, Fishers, IN (US); Christopher DeSchamp, Fishers, IN (US)

(21) Appl. No.: 16/220,713

(22) Filed: Dec. 14, 2018

Related U.S. Application Data
(60) Provisional application No. 62/607,675, filed on Dec. 19, 2017.

(51) Int. Cl. H04L 12/28

(52) U.S. Cl. CPC H04L 12/2827; H04L 2012/285

(57) ABSTRACT

Technologies for monitoring the performance of one or more electrical devices at one or more sites include a compute device. The compute device is to obtain data indicative of characteristics of resource usage by a monitored device. The data is usable to identify the monitored device and an operation of the monitored device. The compute device is further to determine, as a function of the identity of monitored device and the operation of the monitored device, an inference indicative of a condition of the monitored device, and send, to another compute device, a notification as a function of the determined inference. Other embodiments are also described and claimed.

### CROSS-REFERENCE TO RELATED APPLICATIONS

The present application claims the benefit of U.S. Provisional Patent Application No. 62/607,675, filed Dec. 19, 2017.

### BACKGROUND

Typically, in a house or other building, referred to herein as a site, a variety of devices may be used to perform routine functions, such as washing items (e.g., dishes, clothes, etc.), providing heat and/or cooling with a heating, ventilation, and air conditioning (HVAC) system and/or a water heater, providing refrigeration, and/or other functions. These devices typically include many components that may degrade over time and fail unexpectedly, rendering the device unusable and causing logistical problems for a user of the devices. Furthermore, while a manufacturer of a device may provide a user with maintenance information and an estimate of the lifetime of a device, variations in peoples' use of the devices and environmental conditions, such as differences in weather patterns in different geographical areas, may significantly affect the actual lifetime of a device, leading to uncertainty and risk for a user.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for monitoring the performance of one or more devices located at one or more sites;

FIG. 2 is a simplified block diagram of at least one embodiment of a monitor server of the system of FIG. 1;

FIG. 3 is a simplified block diagram of at least one embodiment of an environment that may be established by the monitor server of FIGS. 1 and 2; and

FIGS. 4-6 are a simplified flow diagram of at least one embodiment of a method for monitoring the performance of one or more devices that may be performed by the monitor server of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

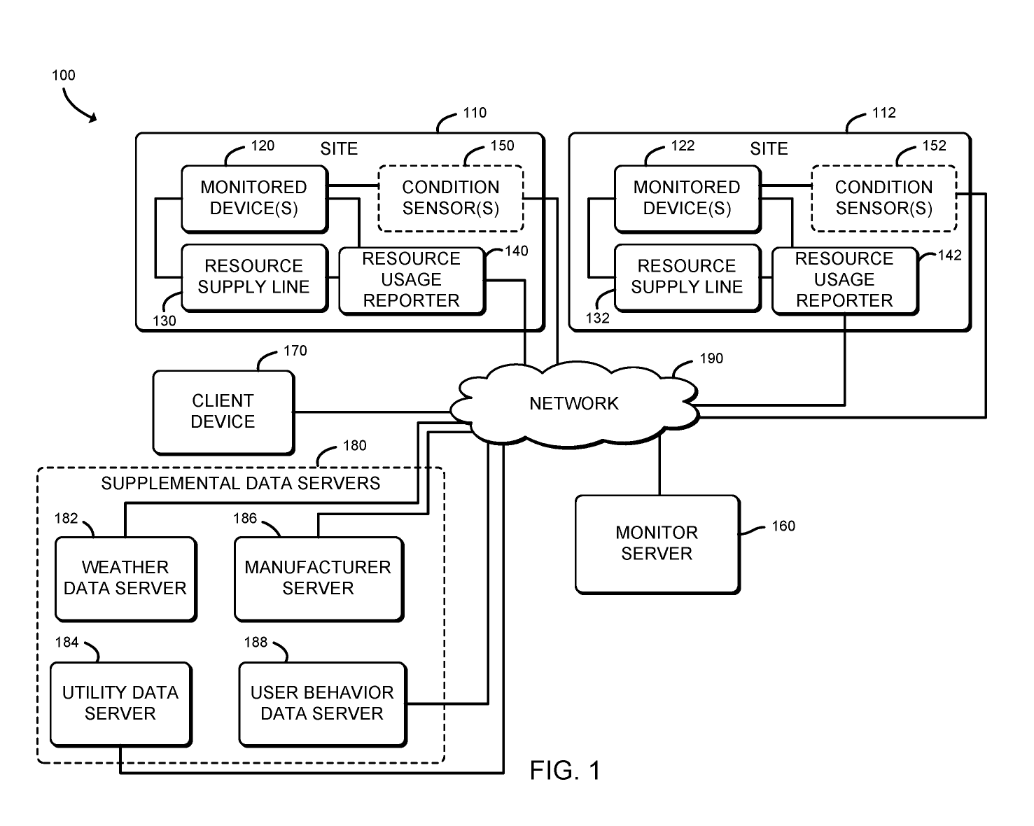

Referring now to FIG. 1, a system 100 for monitoring the performance of one or more devices located at one or more sites includes a monitor server 160 communicatively coupled to resource usage reporters 140, 142, condition sensors 150, 152, a client device 170, and supplemental data servers 180, including a weather data server 182, a utility data server 184, a manufacturer server 186, and a user behavior data server 188. In other embodiments, the number of resource usage reporters 140, 142, condition sensors 150, client devices 170, supplemental data servers 180, monitored devices 120, 122, and/or sites 110, 112 may be different. The monitor server 160, in operation, receives signature data from each resource usage reporter 140, 142 each of which may be embodied as any device or circuitry (e.g., a compute device) capable of detecting and reporting (e.g., sending) characteristics of the usage of one or more resources (e.g., electricity, gas, water, etc.) provided by the resource supply line 130, 132 (e.g., an electricity supply line, a gas supply line, a water supply line) of the corresponding site 110, 112 (e.g., a house or other building) to the monitor server 160 through a network 190. The characteristics may be a series of data points indicative of an amplitude of a voltage or current per increment of time (e.g., per millisecond), a strength of electrical power provided through the resource supply line 130, a peak amount of the resource (e.g., electricity, gas, water) provided to one or more of the monitored devices 120 during a predefined time period, timestamps of when each monitored device 120 used a given resource (e.g., electricity, gas, water) and the amount used, and/or other data indicative of the usage of resources. In some embodiments, one or more of the monitored devices 120, 122 may be battery powered. As described herein, the monitored devices 120, 122 at each site 110, 112 exhibit different resource usages as the devices perform operations (e.g., are powered on, are powered off, change from one operation to another, such as from a washing cycle to a spinning cycle in a washing machine, etc.) and the resource usages are unique to the monitored devices and their operations. As such, in operation, the monitor server 160 may identify the resource usages as signatures of the corresponding monitored devices 120, 122 and their corresponding operations, and draw inferences as to their present status (e.g., their performance conditions, such as their total amount of running time, an amount of degradation of components within each monitored device 120, 122, an amount of time remaining before the monitored device 120, 122 is likely to fail, etc.) as described in more detail herein. In some embodiments, the monitor server 160 does not directly analyze the signature data to identify the monitored devices and their operations but rather receives pre-processed data (e.g., from a third party server) indicative of the identified operations and the corresponding monitored devices 120, 122.

Additionally or alternatively, the monitor server 160 may receive supplemental data from condition sensors 150, 152 located at the corresponding sites 110, 112. Each condition sensor 150, 152 may be embodied as any device or circuitry (e.g., a water leak sensor, a gas leak sensor, a smoke detector, a radon detector, etc.) capable of detecting the presence of a predefined condition and reporting the presence of the condition to another compute device (e.g., the monitor server 160). In some embodiments, the monitor server 160 may receive the supplemental data from the condition sensors 150, 152, without receiving data from the resource usage reporters 140, 142, and draw inferences as to conditions at one or more of the sites 110, 112 based on the received supplemental data (e.g., without resource usage data from the resource usage reporters 140, 142). Further, the monitor server 160 may receive supplemental data from the supplemental data servers 180, including a weather data server 182, which may send data indicative of weather patterns at each site, a utility data server 184 which may send data indicative of an amount of a particular resource (e.g., electricity, gas, water, etc.) utilized at each site 110, 112, a manufacturer server 186, which may send data indicative of known issues (e.g., defects) of one or more devices, and/or a user behavior server 188, which may send data indicative of user behaviors with respect to one or more monitored devices 120, 122, such as when and how often a user opens a refrigerator, temperature settings for the refrigerator and/or HVAC system, and/or other user behavior data. As such, in some embodiments, the monitor server 160 may draw inferences based additionally on the supplemental data. As referenced above, in some embodiments, the monitor server 160 may draw the inferences based only on the supplemental data, without relying on or receiving data from the resource usage reporters 140, 142. In the illustrative embodiment, and as described in more detail herein, the monitor server 160 may provide notifications to other compute devices (e.g., the client device 170) indicative of an inference regarding the condition of one or more of the monitored devices 120, 122 such as a warning that a monitored device may fail within a predefined time period (e.g., within one month).

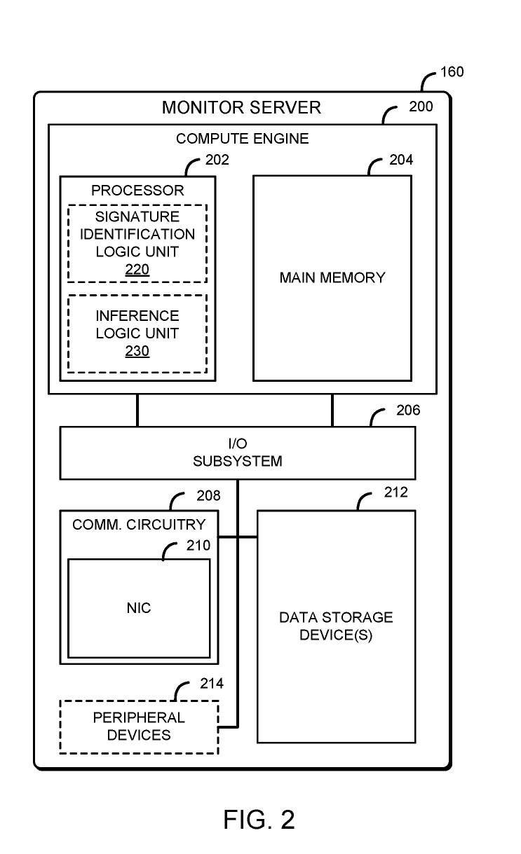

Referring now to FIG. 2, the monitor server 160 may be embodied as any type of compute device capable of performing the functions described herein, including receiving signature data indicative of attributes of the utilization of one or more resources by one or more monitored devices 120, identifying, as a function of the signature data, the monitored device and an operation of the monitored device, determining, as a function of the identification of the monitored device and the identified operation of the monitored device, an inference indicative of a condition of the monitored device, and sending a notification (e.g., to the client device 170) as a function of the determined inference.

As shown in FIG. 2, the illustrative monitor server 160 includes a compute engine 200, an input/output (I/O) subsystem 206, communication circuitry 208, and one or more data storage devices 212. Of course, in other embodiments, the monitor server 160 may include other or additional components, such as those commonly found in a computer (e.g., display, peripheral devices, etc.). Additionally, in some embodiments, one or more of the illustrative components may be incorporated in, or otherwise form a portion of, another component.

The compute engine 200 may be embodied as any type of device or collection of devices capable of performing various compute functions described below. In some embodiments, the compute engine 200 may be embodied as a single device such as an integrated circuit, an embedded system, a field-programmable gate array (FPGA), a system-on-a-chip (SOC), or other integrated system or device. Additionally, in some embodiments, the compute engine 200 includes or is embodied as a processor 202 and a memory 204. The processor 202 may be embodied as any type of processor capable of performing the functions described herein. For example, the processor 202 may be embodied as a single or multi-core processor(s), a microcontroller, or other processor or processing/controlling circuit. In some embodiments, the processor 202 may be embodied as, include, or be coupled to an FPGA, an application specific integrated circuit (ASIC), reconfigurable hardware or hardware circuitry, or other specialized hardware to facilitate performance of the functions described herein. Additionally, in the illustrative embodiment, the processor 202 includes a signature identification logic unit 220, which may be embodied as any circuitry or device (e.g., an FPGA, an ASIC, a co-processor, etc.) capable of comparing signature data provided by the resource usage reporters 140, 142 to a database of known signatures of devices (e.g., dishwashers, HVAC systems, garage doors, etc.) and their operations and identifying a matching device and operation of the device. Further, in the illustrative embodiment, the processor 202 includes an inference logic unit 230, which may be embodied as any circuitry or device (e.g., an FPGA, an ASIC, a co-processor, etc.) capable of drawing inferences as to the present and/or future condition (e.g., a predicted timeline for becoming inoperative) of a monitored device based on a model of the operations of each monitored device over time and a database of known lifetimes and conditions of the monitored devices under varying loads (e.g., amount of stress caused by user behaviors, weather patterns, etc.).

The main memory 204 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 204 may be integrated into the processor 202. In operation, the main memory 204 may store various software and data used during operation such as signature data, supplemental data, inference data, notification data, applications, programs, libraries, and drivers.

The compute engine 200 is communicatively coupled to other components of the monitor server 160 via the I/O subsystem 206, which may be embodied as circuitry and/or components to facilitate input/output operations with the compute engine 200 (e.g., with the processor 202 and/or the main memory 204) and other components of the monitor server 160. For example, the I/O subsystem 206 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 206 may form a portion of a system-on-a-chip (SoC) and be incorporated, along with one or more of the processor 202, the main memory 204, and other components of the monitor server 160, into the compute engine 200.

The communication circuitry 208 may be embodied as any communication circuit, device, or collection thereof, capable of enabling communications over the network 190 between the monitor server 160 and another compute device (e.g., the resource usage reporters 140, 142, the condition sensors 150, 152, the supplemental data servers 180, the client device 170, etc.). The communication circuitry 208 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 208 includes a network interface controller (NIC) 210. The NIC 210 may be embodied as one or more add-in-boards, daughter cards, network interface cards, controller chips, chipsets, or other devices that may be used by the monitor server 160 to connect with another compute device (e.g., the resource usage reporters 140, 142, the condition sensors 150, 152, the supplemental data servers 180, the client device 170, etc.). In some embodiments, the NIC 210 may be embodied as part of a system-on-a-chip (SoC) that includes one or more processors, or included on a multichip package that also contains one or more processors. In some embodiments, the NIC 210 may include a local processor (not shown) and/or a local memory (not shown) that are both local to the NIC 210. In such embodiments, the local processor of the NIC 210 may be capable of performing one or more of the functions of the compute engine 200 described herein. Additionally or alternatively, in such embodiments, the local memory of the NIC 210 may be integrated into one or more components of the monitor server 160 at the board level, socket level, chip level, and/or other levels.

The one or more illustrative data storage devices 212, may be embodied as any type of devices configured for short-term or long-term storage of data such as, for example, memory devices and circuits, memory cards, hard disk drives, solid-state drives, or other data storage devices. Each data storage device 212 may include a system partition that stores data and firmware code for the data storage device 212. Each data storage device 212 may also include an operating system partition that stores data files and executables for an operating system.

Additionally or alternatively, the monitor server 160 may include one or more peripheral devices 214. Such peripheral devices 214 may include any type of peripheral device commonly found in a compute device such as a display, speakers, a mouse, a keyboard, and/or other input/output devices, interface devices, and/or other peripheral devices.

The resource usage reporters 140, 142, the condition sensors 150, 152, the supplemental data servers 180, and the client device 170 may have components similar to those described in FIG. 2, with the exception of not including the signature identification logic unit 220 and the inference logic unit 230. The description of those components of the monitor server 160 is equally applicable to the description of components of the resource usage reporters 140, 142, the condition sensors 150, 152, the supplemental data servers 180, and the client device 170 and is not repeated herein for clarity of the description. Further, it should be appreciated that the resource usage reporters 140, 142, the condition sensors 150, 152, the supplemental data servers 180, and the client device 170 may include other components, sub-components, and devices commonly found in a computing device, which are not discussed above in reference to the monitor server 160 and not discussed herein for clarity of the description.

As described above, the monitor server 160, the resource usage reporters 140, 142, the condition sensors 150, 152, the supplemental data servers 180, and the client device 170 are illustratively in communication via the network 190, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), or any combination thereof.

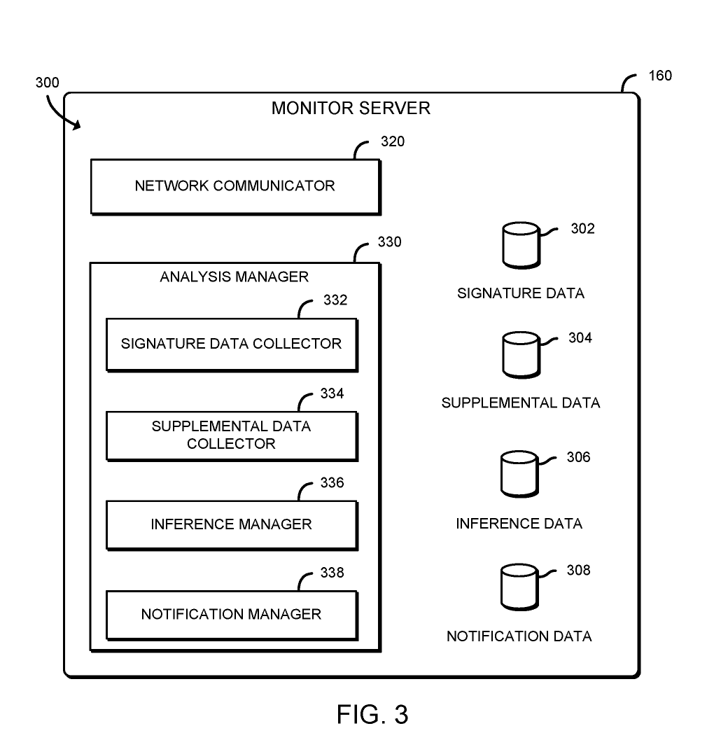

Referring now to FIG. 3, the monitor server 160 may establish an environment 300 during operation. The illustrative environment 300 includes a network communicator 320 and an analysis manager 330. Each of the components of the environment 300 may be embodied as hardware, firmware, software, or a combination thereof. As such, in some embodiments, one or more of the components of the environment 300 may be embodied as circuitry or a collection of electrical devices (e.g., network communicator circuitry 320, analysis manager circuitry 330, etc.). It should be appreciated that, in such embodiments, one or more of the network communicator circuitry 320 or analysis manager circuitry 330 may form a portion of one or more of the compute engine 200, the signature identification logic unit 220, the inference logic unit 230, the communication circuitry 208, the I/O subsystem 206, and/or other components of the monitor server 160. In the illustrative embodiment, the environment 300 includes signature data 302, which may be embodied as any data indicative of characteristics reported by the resource usage reporters 140, 142 of the usage by one or more monitored devices 120, 122 of resources provided through the resource supply lines 130, 132 and a database of known characteristic effects on the resources usages (e.g., signatures) caused by different operations of different devices (e.g., the beginning of a wash cycle of a particular model of a washing machine, the lighting of a pilot flame by a particular model of water heater, the beginning of a water filtration cycle in a pool water filtration system, etc.). Additionally, in the illustrative embodiment, the environment 300 includes supplemental data 304 which may be embodied as any data indicative of conditions that may affect the operation of one or more of the monitored devices 120, 122 (e.g., weather pattern data, utility usage data, user behavior data, etc.). In some embodiments, the signature data 302 may additionally include known signatures indicative of malfunctioning components and/or signatures associated with different levels of wear on different components (e.g., a signature associated with a leaky capacitor or a failing rotor unit in an electrical motor, etc.). Further, in the illustrative embodiment, the environment 300 includes inference data 306, which may be embodied as any data usable by the monitor server 160 to determine an inference as to the present and/or a future condition of a monitored device as a function of the detected operations of the monitored device and any known supplemental data pertaining to the operation of the device (e.g., weather data, user behavior data) that may affect the load on the monitored device. As such, the inference data 306 may include data indicative of an average expected lifetime for a particular monitored device and variations on the average expected lifetime under different loads. The environment 300, in the illustrative embodiment, also includes notification data 308 which may be embodied as any data indicative of notifications that have been or are scheduled to be sent out to one or more compute devices (e.g., the client device 170) indicative of an inference determined by the monitor server 160, as described in more detail herein.

In the illustrative environment 300, the network communicator 320, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the monitor server 160, respectively. To do so, the network communicator 320 is configured to receive and process data packets from one system or computing device (e.g., a resource usage reporter 140) and to prepare and send data packets to another computing device or system (e.g., the client device 170). Accordingly, in some embodiments, at least a portion of the functionality of the network communicator 320 may be performed by the communication circuitry 208, and, in the illustrative embodiment, by the NIC 210.

The analysis manager 330, which may be embodied as hardware, firmware, software, virtualized hardware, emulated architecture, and/or a combination thereof, is configured to analyze the signature data 302 and supplemental data 304, infer a condition of each monitored device 120, 122 associated with the signature data 302, and selectively send out notifications as to the inferred condition of one or more of the monitored devices 120, 122 (e.g., that a monitored device 120, 122 is predicted to fail within a month, that a monitored device 120, 122 is malfunctioning, etc.). To do so, in the illustrative embodiment, the monitor server 160 includes a signature data collector 332, a supplemental data collector 334, an inference manager 336, and a notification manager 338. The signature data collector 332, in the illustrative embodiment, is configured to receive the signature data 302 from the resource usage reporters 140, 142 and store the signature data 302 for analysis, as described in more detail herein. In doing so, the signature data collector 332 may poll each resource usage reporter 140, 142 for new signature data 302 (e.g., at periodic intervals) and/or may passively receive the signature data 302 from the resource usage reporters 140, 142 (e.g., without prompting the resource usage reporters 140, 142 for the signature data 302). Similarly, the supplemental data collector 334 is configured to receive the supplemental data 304 from one or more sources, such as the supplemental data servers 180, the condition sensors 150, 152, the client device 170 (e.g., user-provided information about operating settings the user has input to one or more the monitored devices 120, 122, an amount of food the user typically places in a refrigerator, and/or other information indicative of user behaviors). The supplemental data collector 334 may receive the supplemental data 304 by actively polling the various sources for the supplemental data 304 and/or may receive the supplemental data 304 passively (e.g., without prompting).

The inference manager 336, in the illustrative embodiment, is configured to determine inferences as to the present and/or future condition (e.g., a predicted timeline for becoming inoperative, whether a device is presently malfunctioning or operating outside of predefined parameters, etc.) of a monitored device 120, 122 based on a model of the operations of each monitored device 120, 122 over time and a database of known lifetimes and conditions of devices under varying loads (e.g., the inference data 306). The notification manager 338, in the illustrative embodiment, is configured to send notifications to other compute devices (e.g., the client device 170) indicative of inferences determined by the inference manager 336 (e.g., that a particular monitored device 120, 122 is likely to fail to within a predefined time period, such as a month, that a device is presently malfunctioning or operating outside of predefined parameters, etc.). In some embodiments, the notification manager 338 may send the notification to a party other than the owner or operator of the monitored device 120, 122. For example, the notification manager 338 may send a notification to a device manufacturer indicating that the monitored device 120, 122 is about to fail or is operating abnormally, thereby enabling the manufacturer to offer a replacement of the monitored device 120, 122 or otherwise respond to the condition of the monitored device 120, 122.

It should be appreciated that each of the signature data collector 332, the supplemental data collector 334, the inference manager 336, and the notification manager 338 may be separately embodied as hardware, firmware, software, virtualized hardware, emulated architecture, and/or a combination thereof. For example, the signature data collector 332 may be embodied as a hardware component, while each of the supplemental data collector 334, the inference manager 336, and the notification manager 338 is embodied as a virtualized hardware component or as some other combination of hardware, firmware, software, virtualized hardware, emulated architecture, and/or a combination thereof.

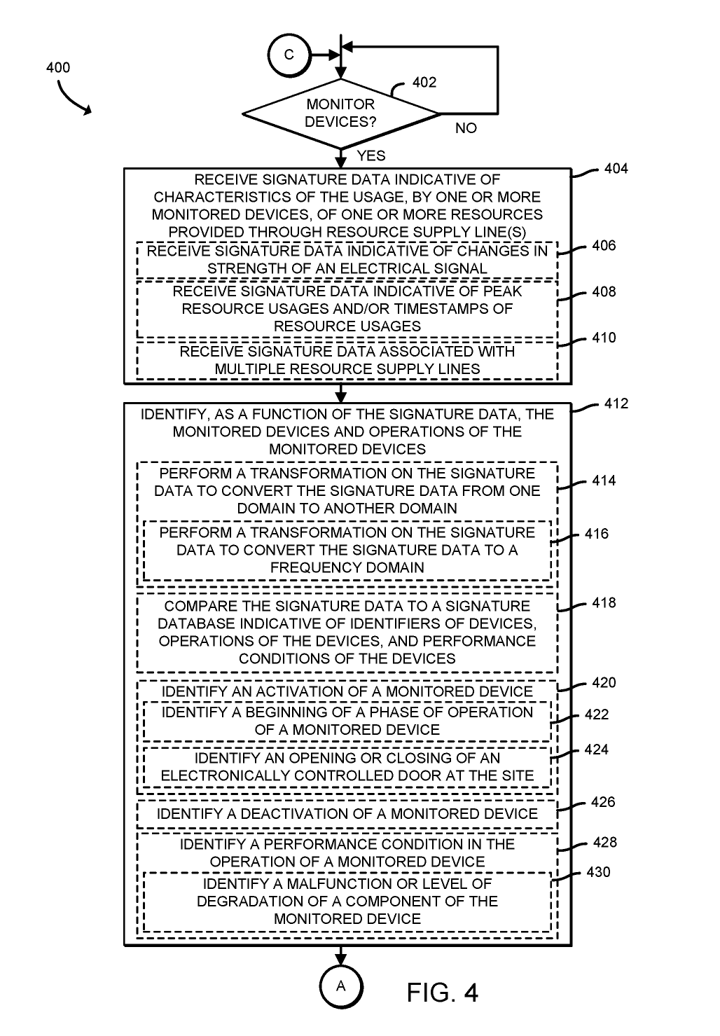

Referring now to FIG. 4, the monitor server 160, in operation, may execute a method 400 to monitor the performance of one or more devices (e.g., the monitored devices 120, 122). The method 400 begins with block 402 in which the monitor server 160 determines whether to monitor one or more devices (e.g., the monitored devices 120, 122). In the illustrative embodiment, the monitor server 160 may determine to monitor one or more devices if the monitor server 160 is communicatively coupled to one or more corresponding resource usage reporters 140, 142 (e.g., through the network 190). In other embodiments, the monitor server 160 may determine whether to monitor one or more devices based on other criteria. Regardless, in response to a determination to monitor one or more devices, the method 400 advances to block 404 in which the monitor server 160 receives signature data indicative of characteristics of the usage, by one or more monitored devices, of one or more resources provided to the monitored devices 120, 122 through a corresponding resource supply line (e.g., the resource supply lines 130, 132). In doing so, the monitor server 160 may receive signature data indicative of changes in the strength of an electrical signal, as indicated in block 406. In other embodiments, the monitor server 160 may receive signature data indicative of other characteristics of the resource usages, such as a peak resource usage during a predefined time period, timestamps of when one or more resources were used by each monitored device 120, 122 and/or the amount of each resource used, as indicated in block 408. As indicated in block 410, in the illustrative embodiment, the monitor server 160 receives signature data associated with multiple resource supply lines (e.g., the resource supply lines 130, 132) from multiple remote sites (e.g., the remote sites 110, 112).

Additionally, as indicated in block 412, the monitor server 160 identifies, as a function of the signature data received in block 404, the monitored devices and the operations of the monitored devices. In doing so, the monitor server 160 may perform a transformation of the signature data from one domain to another domain, as indicated in block 414. For example, and as indicated in block 416, the monitor server 160 may perform a transformation on the signature data to convert the signature data to a frequency domain (e.g., from a time domain), such as with a Fourier transform. As indicated in block 418, the monitor server 160 may compare the signature data to a signature database indicative of identifiers of devices (e.g., model numbers, serial numbers), operations of the devices (e.g., activating a device, deactivating the device, a transition from one phase of operation to another phase of operation such as a transition from a rinse cycle to a drying cycle, etc.), and conditions of the devices (e.g., a degradation in a rotor in an electrical motor that generates a unique signature). In the illustrative embodiment, the monitor server 160 may identify an activation of a monitored device, as indicated in block 420. In doing so, the monitor server 160 may identify a beginning of a phase of operation of a monitored device (e.g., a washing cycle, a drying cycle in a dishwasher, a regeneration cycle in a water softener, etc.), as indicated in block 422. Further, in some embodiments, the monitor server 160 may identify a deactivation of a monitored device, as indicated in block 426. In the illustrative embodiment, and as indicated in block 428, the monitor server 160 may identify a performance condition in the operation of a monitored device, as indicated in block 428. For example, and as indicated in block 430, the monitor server 160 may identify a malfunction or a level of degradation of a component of the monitored device (e.g., a malfunction in a rotor), as indicated in block 430. In some embodiments, the monitor server 160 does not directly analyze the signature data to identify operations of the monitored devices but rather receives pre-processed data (e.g., from a third party server (not shown)) indicative of the identified operations and the corresponding monitored devices.

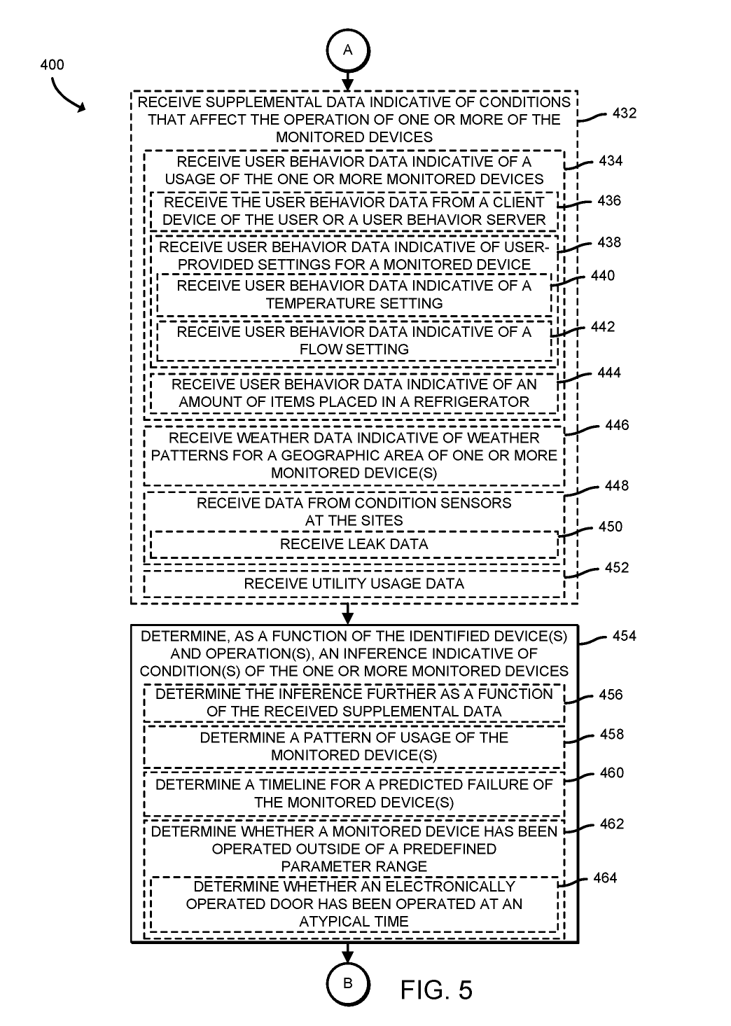

Subsequently, the method advances to block 432 of FIG. 5, in which the monitor server 160, in the illustrative embodiment, receives supplemental data (e.g., the supplemental data 304) indicative of conditions that may affect the operation of one or more of the monitored devices 120, 122. Referring now to FIG. 5, in receiving the supplemental data, the monitor server 160 may receive user behavior data indicative of a usage of the one or more monitored devices 120, 122, as indicated in block 434. For example, and as indicated in block 436, the monitor server 160 may receive the user behavior data from a client device (e.g., the client device 170) of the user of a monitored device (e.g., a homeowner whose devices 120 are being monitored) and/or from the user behavior data server 188. As indicated in block 438, the monitor server 160 may receive user behavior data indicative of user-provided settings for a monitored device 120. In doing so, the monitor server 160 may receive user behavior data indicative of a temperature setting (e.g., for a clothes dryer), as indicated in block 440. As another example, the monitor server 160 may receive user behavior data indicative of a flow setting (e.g., gallons per minute to be pumped by a water pump of a pool, a number of cubic feet per minute to be moved by a fan in an HVAC system, etc.), as indicated in block 442. Additionally or alternatively, the monitor server 160 may receive user behavior data indicative of an amount of items placed in a refrigerator, as indicated in block 444. In the illustrative embodiment, the monitor server 160 also receives weather data (e.g., from the weather data server 182) indicative of weather patterns for a geographic area of one or more of the monitored devices 120, 122, as indicated in block 446. The monitor server 160 may also receive data from condition sensors at the sites (e.g., the condition sensors 150, 152), as indicated in block 448. In doing so, the monitor server 160 may receive leak data (e.g., data indicative of the presence of a gas leak and/or a water leak), indicating that a particular monitored device may be faulty (e.g., leaking) and/or may be operating with an above average load (e.g., in the case of a pump) to compensate for the leakage, as indicated in block 450. In some embodiments, the monitor server 160 may additionally or alternatively receive utility usage data (e.g., from the utility data server 184) indicative of an amount of a particular resource (e.g., electricity, gas, water) utilized by one or more of the monitored devices 120, 122, as indicated in block 452. In some embodiments, the monitor server 160 may also receive information indicative of known issues (e.g., defects) with one or more devices, such as from the manufacturer server 186.

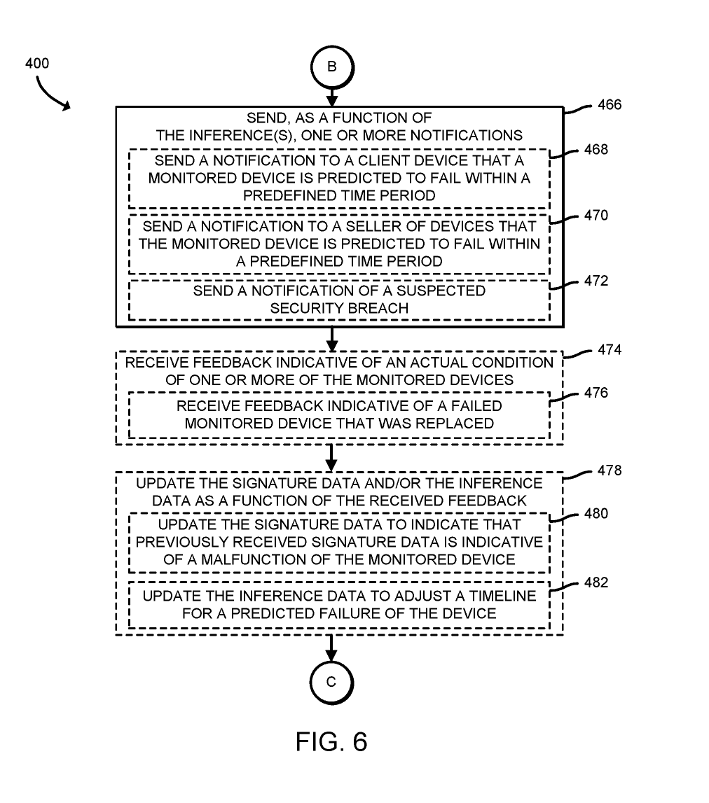

Subsequently, in block 454, the monitor server 160 may determine, as a function of the identified devices (e.g., the monitored devices 120, 122) and their identified operations, an inference indicative of the condition of each of the monitored devices 120, 122. In doing so, and as indicated in block 456, the monitor server 160 may additionally determine the inference using the supplemental data received in block 432. In some embodiments, the monitor server 160 may draw the inferences based only on the supplemental data, without relying on or receiving data from the resource usage reporters 140, 142. As indicated in block 458, the monitor server 160 may determine a pattern of usage of the monitored devices 120, 122 (e.g., typical hours of operation). In doing so, the monitor server 160 may additionally determine an estimated total amount of time that each monitored device 120, 122 has been operated. As such, the monitor server 160 may determine a timeline for a predicted failure of each monitored device 120, 122 (e.g., by comparing the total operating time, any degradation of components indicated in the signature data, and any supplemental data indicative of an above average or below average load on the monitored device, to predefined timelines associated with each monitored device in the inference data 306), as indicated in block 460. Additionally, the monitor server 160 may determine whether a monitored device 120, 122 has been operated outside of a predefined parameter range, as indicated in block 462. For example, and as indicated in block 424, the monitor server 160 may determine that an electronically operated door (e.g., a garage door) has been operated at an atypical time (e.g., at 3 AM) based on a comparison of a door activation signature to earlier signatures indicative of activations of the door, as indicated in block 464. Such information may be indicative of a security breach at the corresponding site. Subsequently, the method 400 advances to block 466 of FIG. 6, in which the monitor server 160 sends, as a function of the one or more inferences, one or more notifications (e.g., through the network 190).

Referring now to FIG. 6, as indicated in block 468, in sending one or more notifications, the monitor server 160 may send a notification to a client device (e.g., the client device 170) indicating that a monitored device 120, 122 is predicted to fail within a predefined time period (e.g., one month). In some embodiments, the predefined time period within which to send a notification of predicted failure may be set by a user (e.g., through the client device 170). As indicated in block 470, the monitor server 160 may send a notification to a seller of devices (e.g., electronic devices) that a monitored device 120, 122 is predicted to fail within a predefined time period. Subsequently, the seller may contact the user of the monitored device to discuss repair or replacement of the monitored device. Additionally or alternatively, as indicated in block 472, the monitor server 160 may send a notification indicative of a suspected security breach (e.g., if a garage door was opened at an atypical time as discussed with reference to block 464 of FIG. 5). Subsequently, in block 474, the monitor server 160 may receive feedback indicative of an actual condition of one or more of the monitored devices 120, 122. In doing so, and as indicated in block 476, the monitor server 160 may receive feedback indicating that a failed monitored device was replaced. The feedback data may be submitted by the client device 170 (e.g., by the user of the monitored device 120, 122 that was replaced) and/or from another source.

In block 478, the monitor server 160 may update the signature data 302 and/or the inference data 306 as a function of the received feedback from block 474. For example, the monitor server 160 may update the signature data to indicate that previously received signature data is indicative of a malfunction in the monitored device 120 that was replaced, as indicated in block 480. Additionally or alternatively, the monitor server 160 may update the inference data 306 to adjust a timeline for a predicted failure of the monitored device 120 (e.g., if the timeline previously indicated in the inference data was longer than the actual timeline), as indicated in block 482. As such, by continually updating the signature data 302 and inference data 306 over time, the monitor server 160 may predict future failures of monitored devices with more accuracy. Subsequently, the method 400 loops back to block 402 of FIG. 4 to determine whether to continue to monitor electronic devices. It should be appreciated that while the data receiving operations are shown in a particular order with respect to each other and to the operations in which the received data is analyzed, it should be understood that in other embodiments, the data may be received in a different order and/or may be received while other operations in the method 400 are being performed.

### EXAMPLES

Illustrative examples of the technologies disclosed herein are provided below. An embodiment of the technologies may include any one or more, and any combination of, the examples described below.

Example 1 includes a compute device comprising a compute engine to obtain data indicative of characteristics of resource usage by a monitored device, wherein the data is usable to identify the monitored device and an operation of the monitored device; determine, as a function of the identity of monitored device and the operation of the monitored device, an inference indicative of a condition of the monitored device; and send, to another compute device, a notification as a function of the determined inference.

Example 2 includes the subject matter of Example 1, and wherein to determine an inference as a function of the signature data comprises to determine a timeline for a predicted failure of the monitored device; and wherein to send a notification comprises to send a notification that the monitored device is predicted to fail within a predefined time period.

Example 3 includes the subject matter of any of Examples 1 and 2, and wherein the compute engine is further to receive supplemental data indicative of a condition that affects an operation of the monitored device; and wherein to determine the inference further comprise to determine the inference further as a function of the supplemental data.

Example 4 includes the subject matter of any of Examples 1-3, and wherein to receive the supplemental data comprises to receive user behavior indicative of user-provided settings for the monitored device.

Example 5 includes the subject matter of any of Examples 1-4, and wherein to receive the supplemental data comprises to receive weather data indicative of weather patterns for a geographic area of the monitored device.

Example 6 includes the subject matter of any of Examples 1-5, and wherein to receive the supplemental data comprises to receive leak data from one or more condition sensors associated with the monitored device.

Example 7 includes the subject matter of any of Examples 1-6, and wherein to obtain the data indicative of characteristics of resource usage comprises to receive signature data indicative of attributes of an electrical signal of a resource supply line to which the monitored device is connected, and the compute engine is further to identify, as a function of the signature data, the monitored device and the operation of the monitored device.

Example 8 includes the subject matter of any of Examples 1-7, and wherein the compute engine is further to receive feedback data indicative of an actual condition of the monitored device; and update, as a function of the received feedback data, one or more of the signature data or inference data.

Example 9 includes the subject matter of any of Examples 1-8, and wherein to identify, as a function of the signature data, the monitored device and an operation of the monitored device comprises to compare the signature data to a signature database indicative of identifiers of devices, operations of the devices, and performance conditions of the devices.

Example 10 includes the subject matter of any of Examples 1-9, and wherein to identify a monitored device and a function of the monitored device comprises to identify a malfunction or level of degradation of a component of the monitored device.

Example 11 includes the subject matter of any of Examples 1-10, and wherein to identify a monitored device and a function of the monitored device comprises to identify an activation or a deactivation of a monitored device.

Example 12 includes the subject matter of any of Examples 1-11, and wherein to identify an activation of a monitored device comprises to identify a beginning of a phase of operation of a monitored device.

Example 13 includes the subject matter of any of Examples 1-12, and wherein to identify an activation of a monitored device comprises to identify an opening or closing of an electronically controlled door.

Example 14 includes the subject matter of any of Examples 1-13, and wherein to determine the inference comprises to determine whether the electronically operated door has been operated at a time outside of a predefined parameter range; and wherein to send a notification comprises to send a notification of a suspected security breach.

Example 15 includes the subject matter of any of Examples 1-14, and wherein to obtain data indicative of characteristics of resource usage comprises to obtain data indicative of characteristics of the usage of electricity, gas, or water.

Example 16 includes a method comprising obtaining, by a compute device, data indicative of characteristics of resource usage by a monitored device, wherein the data is usable to identify the monitored device and an operation of the monitored device; determining, by the compute device and as a function of the identity of the monitored device and the operation of the monitored device, an inference indicative of a condition of the monitored device; and sending, to another compute device, a notification as a function of the determined inference.

Example 17 includes the subject matter of Example 16, and wherein determining an inference as a function of the signature data comprises determining a timeline for a predicted failure of the monitored device; and wherein sending a notification comprises sending a notification that the monitored device is predicted to fail within a predefined time period.

Example 18 includes the subject matter of any of Examples 16 and 17, and further including receiving, by the compute device, supplemental data indicative of a condition that affects an operation of the monitored device; and wherein determining the inference further comprises determining the inference further as a function of the supplemental data.

Example 19 includes the subject matter of any of Examples 16-18, and wherein receiving the supplemental data comprises receiving user behavior indicative of user-provided settings for the monitored device.

Example 20 includes the subject matter of any of Examples 16-19, and wherein receiving the supplemental data comprises receiving weather data indicative of weather patterns for a geographic area of the monitored device.

Example 21 includes the subject matter of any of Examples 16-20, and wherein receiving the supplemental data comprises receiving leak data from one or more condition sensors associated with the monitored device.

Example 22 includes the subject matter of any of Examples 16-21, and wherein obtaining the data indicative of characteristics of resource usage comprises receiving signature data indicative of attributes of an electrical signal of a resource supply line to which the monitored device is connected, and the method further comprising identifying, as a function of the signature data, the monitored device and the operation of the monitored device.

Example 23 includes the subject matter of any of Examples 16-22, and further including receiving, by the compute device, feedback data indicative of an actual condition of the monitored device; and updating, by the compute device and as a function of the received feedback data, one or more of the signature data or inference data.

Example 24 includes the subject matter of any of Examples 16-23, and wherein identifying, as a function of the signature data, the monitored device and an operation of the monitored device comprises comparing the signature data to a signature database indicative of identifiers of devices, operations of the devices, and performance conditions of the devices.

Example 25 includes the subject matter of any of Examples 16-24, and wherein identifying a monitored device and a function of the monitored device comprises identifying a malfunction or level of degradation of a component of the monitored device.

Example 26 includes the subject matter of any of Examples 16-25, and wherein identifying a monitored device and a function of the monitored device comprises identifying an activation or a deactivation of a monitored device.

Example 27 includes the subject matter of any of Examples 16-26, and wherein identifying an activation of a monitored device comprises identifying a beginning of a phase of operation of a monitored device.

Example 28 includes the subject matter of any of Examples 16-27, and wherein identifying an activation of a monitored device comprises identifying an opening or closing of an electronically controlled door.

Example 29 includes the subject matter of any of Examples 16-28, and wherein determining the inference comprises determining whether the electronically operated door has been operated at a time outside of a predefined parameter range; and sending a notification comprises sending a notification of a suspected security breach.

Example 30 includes one or more machine-readable storage media comprising a plurality of instructions stored thereon that, in response to being executed, cause a compute device to perform the method of any of Examples 16-29.

Example 31 includes a compute device comprising means for performing the method of any of Examples 16-29.

Example 32 includes a compute device comprising a compute engine to perform the method of any of Examples 16-29.

1. A compute device comprising:
a compute engine to:
obtain data indicative of characteristics of resource usage by a monitored device, wherein the data is usable to identify the monitored device and an operation of the monitored device;
determine, as a function of the identity of monitored device and the operation of the monitored device, an inference indicative of a condition of the monitored device; and
send, to another compute device, a notification as a function of the determined inference.

2. The compute device of claim 1, wherein to determine an inference as a function of the signature data comprises to determine a timeline for a predicted failure of the monitored device; and
wherein to send a notification comprises to send a notification that the monitored device is predicted to fail within a predefined time period.

3. The compute device of claim 1, wherein the compute engine is further to receive supplemental data indicative of a condition that affects an operation of the monitored device; and
wherein to determine the inference further comprise to determine the inference further as a function of the supplemental data.

4. The compute device of claim 3, wherein to receive the supplemental data comprises to receive user behavior indicative of user-provided settings for the monitored device.

5. The compute device of claim 3, wherein to receive the supplemental data comprises to receive weather data indicative of weather patterns for a geographic area of the monitored device.

6. The compute device of claim 3, wherein to receive the supplemental data comprises to receive leak data from one or more condition sensors associated with the monitored device.

7. The compute device of claim 1, wherein to obtain the data indicative of characteristics of resource usage comprises to receive signature data indicative of attributes of an electrical signal of a resource supply line to which the monitored device is connected, and
the compute engine is further to:
identify, as a function of the signature data, the monitored device and the operation of the monitored device.

8. The compute device of claim 7, wherein the compute engine is further to:
receive feedback data indicative of an actual condition of the monitored device; and
update, as a function of the received feedback data, one or more of the signature data or inference data.

9. The compute device of claim 7, wherein to identify, as a function of the signature data, the monitored device and an operation of the monitored device comprises to compare the signature data to a signature database indicative of identifiers of devices, operations of the devices, and performance conditions of the devices.

10. The compute device of claim 9, wherein to identify a monitored device and a function of the monitored device comprises to identify a malfunction or level of degradation of a component of the monitored device.

11. The compute device of claim 9, wherein to identify a monitored device and a function of the monitored device comprises to identify an activation or a deactivation of a monitored device.

12. The compute device of claim 11, wherein to identify an activation of a monitored device comprises to identify a beginning of a phase of operation of a monitored device.

13. The compute device of claim 11, wherein to identify an activation of a monitored device comprises to identify an opening or closing of an electronically controlled door.

14. The compute device of claim 13, wherein:
to determine the inference comprises to determine whether the electronically operated door has been operated at a time outside of a predefined parameter range; and
wherein to send a notification comprises to send a notification of a suspected security breach.

15. The compute device of claim 1, wherein to obtain data indicative of characteristics of resource usage comprises to obtain data indicative of characteristics of the usage of electricity, gas, or water.

16. A method comprising:
obtaining, by a compute device, data indicative of characteristics of resource usage by a monitored device, wherein the data is usable to identify the monitored device and an operation of the monitored device;
determining, by the compute device and as a function of the identity of the monitored device and the operation of the monitored device, an inference indicative of a condition of the monitored device; and
sending, to another compute device, a notification as a function of the determined inference.

17. The method of claim 16, wherein determining an inference as a function of the signature data comprises determining a timeline for a predicted failure of the monitored device; and
wherein sending a notification comprises sending a notification that the monitored device is predicted to fail within a predefined time period.

18. The method of claim 16, further comprising receiving, by the compute device, supplemental data indicative of a condition that affects an operation of the monitored device; and
wherein determining the inference further comprises determining the inference further as a function of the supplemental data.

19. One or more machine-readable storage media comprising a plurality of instructions stored thereon that, in response to being executed, cause a compute device to:
obtain data indicative of characteristics of resource usage by a monitored device, wherein the data is usable to identify the monitored device and an operation of the monitored device;
determine, as a function of the identity of monitored device and the operation of the monitored device, an inference indicative of a condition of the monitored device; and
send, to another compute device, a notification as a function of the determined inference.

20. The one or more machine-readable storage media of claim 19, wherein to determine an inference as a function of the signature data comprises to determine a timeline for a predicted failure of the monitored device; and
wherein to send a notification comprises to send a notification that the monitored device is predicted to fail within a predefined time period
